(19) United States
(12) Patent Application Publication
(10) Pub. No.: US 2023/0213965 A1
(43) Pub. Date: Jul. 6, 2023

(54) Computer Display Accessory Mounts And Configurable Systems Using Same

(71) Applicant: Vitec Imaging Solutions S.P.A., Cassola (VI) (IT)

(72) Inventors: Hen-Li Philip Chao, Livingston, NJ (US); Ryan Winter, Jersey City, NJ (US)

(21) Appl. No.: 18/092,276

(22) Filed: Dec. 31, 2022

Related U.S. Application Data
(60) Provisional application No. 63/295,840, filed on Dec. 31, 2021.

(51) Int. Cl. G06F 1/16; A47B 97/00

(52) U.S. Cl. CPC G06F 1/1607; A47B 97/00; A47B 2097/005

(57) ABSTRACT

A computer display accessory mount system adapted to be used in different configurations. Accessory mounting bars are adapted to be mounted to the rear of a display screen at the locations also used to mount the display to traditional support structures. The accessory mounting bars may have brackets which extend to the traditional mounting locations. The accessory mounting bars may extend out to near the perimeter of the display and provide mounting to accessories, such as lights, microphones, and cameras. The accessories may be mounted to flexible support arms which are in turn mounted to the accessory mounting bars.

### CROSS-REFERENCE TO RELATED APPLICATIONS

This application claims priority to U.S. Provisional Patent Application No. 63/295,840 to Chao, filed Dec. 31, 2021, which is hereby incorporated by reference in its entirety.

### FIELD OF THE INVENTION

This invention relates to computer accessories, namely an accessory mounting bracket and configurable systems using same.

### BACKGROUND

In the modern era computer users may wish to include accessories in their workspace. For example, a user may wish to have camera and lighting coupled to their computer display for videoconferencing. Also, computer gamers may wish to stream their play, including video of the gamer themselves.

What is needed is an accessory mounting system for a computer display which is adapted to be used in a variety of configurations. What is also needed is an accessory mounting system which is easily integrated into standard display mounting systems.

### BRIEF DESCRIPTION OF THE DRAWINGS

FIGS. 1A-C are views of a computer display accessory mounting system with an upper horizontal mounting bar according to some embodiments of the present invention.

FIGS. 2A-C are views of a computer display accessory mounting system with a lower horizontal mounting bar according to some embodiments of the present invention.

FIGS. 3A-C are views of a computer display accessory mounting system with upper and lower horizontal mounting bars according to some embodiments of the present invention.

FIGS. 4A-C are views of a computer display accessory mounting system with a left side vertical mounting bar according to some embodiments of the present invention.

FIGS. 5A-C are views of a computer display accessory mounting system with left and right side vertical mounting bars according to some embodiments of the present invention.

FIGS. 6A-C are views of a computer display accessory mounting system with horizontal and vertical mounting bars according to some embodiments of the present invention.

FIGS. 7A-C are views of a computer display accessory mounting system with an adjustable upper mounting bar according to some embodiments of the present invention.

FIGS. 8A-C are views of a computer display accessory mounting system with upper and lower adjustable mounting bars according to some embodiments of the present invention.

FIGS. 9A-C are views of a computer display accessory mounting system with an adjustable left side mounting bar according to some embodiments of the present invention.

FIGS. 10A-C are views of a computer display accessory mounting system with adjustable left side and right side mounting bars according to some embodiments of the present invention.

FIGS. 11A-C are views of a computer display accessory mounting system with adjustable horizontal and vertical mounting bars according to some embodiments of the present invention.

FIGS. 12A-C are views of a computer display accessory mounting system with a circle light mounted to an upper horizontal mounting bar according to some embodiments of the present invention.

FIGS. 13A-C are views of a computer display accessory mounting system with a camera and microphone mounted to an upper horizontal mounting bar according to some embodiments of the present invention.

FIGS. 14A-C are views of a computer display accessory mounting system with flexible support arms mounted to upper and lower horizontal mounting bars according to some embodiments of the present invention.

FIGS. 15A-C are views of a computer display accessory mounting system with a camera, light, and microphone mounted to an upper horizontal mounting bar according to some embodiments of the present invention.

FIGS. 16A-C are views of a computer display accessory mounting system with accessories mounted to upper and lower horizontal mounting bars according to some embodiments of the present invention.

FIGS. 17A-E are views of a computer display accessory mount according to some embodiments of the present invention.

FIGS. 18A-E are views of a computer display accessory mount system according to some embodiments of the present invention.

FIGS. 19A-E are views of a computer display accessory mount system with mounted accessories according to some embodiments of the present invention.

### SUMMARY

A computer display accessory mount system adapted to be used in different configurations. Accessory mounting bars are adapted to be mounted to the rear of a display screen at the locations also used to mount the display to traditional support structures. The accessory mounting bars may have brackets which extend to the traditional mounting locations. The accessory mounting bars may extend out to near the perimeter of the display and provide mounting to accessories, such as lights, microphones, and cameras. The accessories may be mounted to flexible support arms which are in turn mounted to the accessory mounting bars.

### DETAILED DESCRIPTION

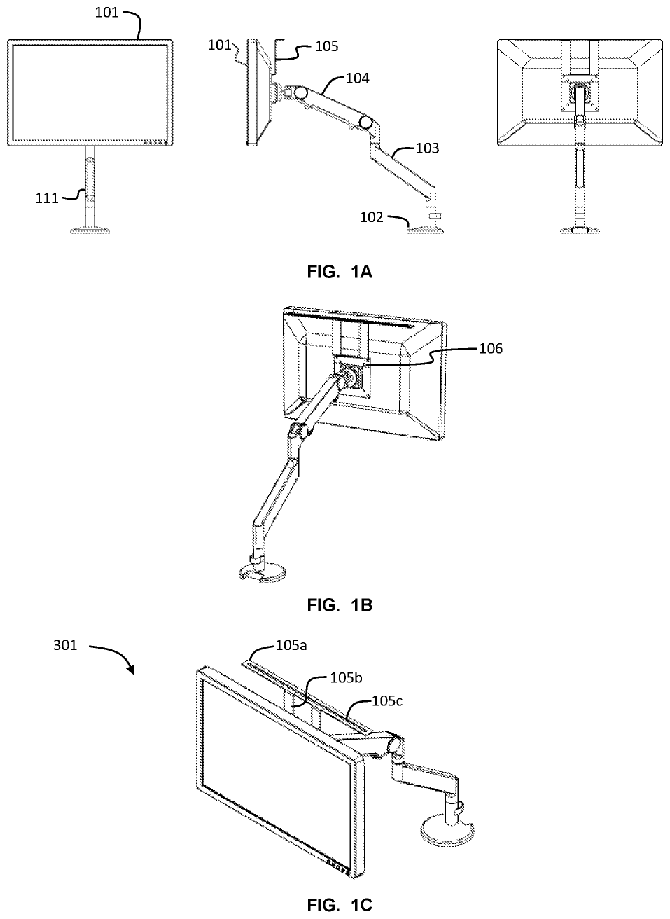

In some embodiments of the present invention, as seen in FIGS. 1A-C, a computer display accessory mount system 301 has a computer display 101 supported by a display support 111. The display support 111 may have a base 102, a lower arm 103, an upper arm 104, and be adapted to allow for movement of the display 101. The display may have a display mount interface 106 on its back side, which may be a standardized interface such as a VESA compliant interface. An upper horizontal mounting bar 105 is adapted to support accessories that may be used with the computer system. The upper horizontal mounting bar 105 has first and second coupling bars 105b which are adapted to utilize the display interface for mounting to the display 101, along with the display support 111. The mounting bar 105a is perpendicular to the coupling bars 105b, and may contain a slot 105c which may allow for the coupling or accessories at different stations along the mounting bar 105a. In some aspects, the mounting bar 105a is positioned just along the periphery of the display.

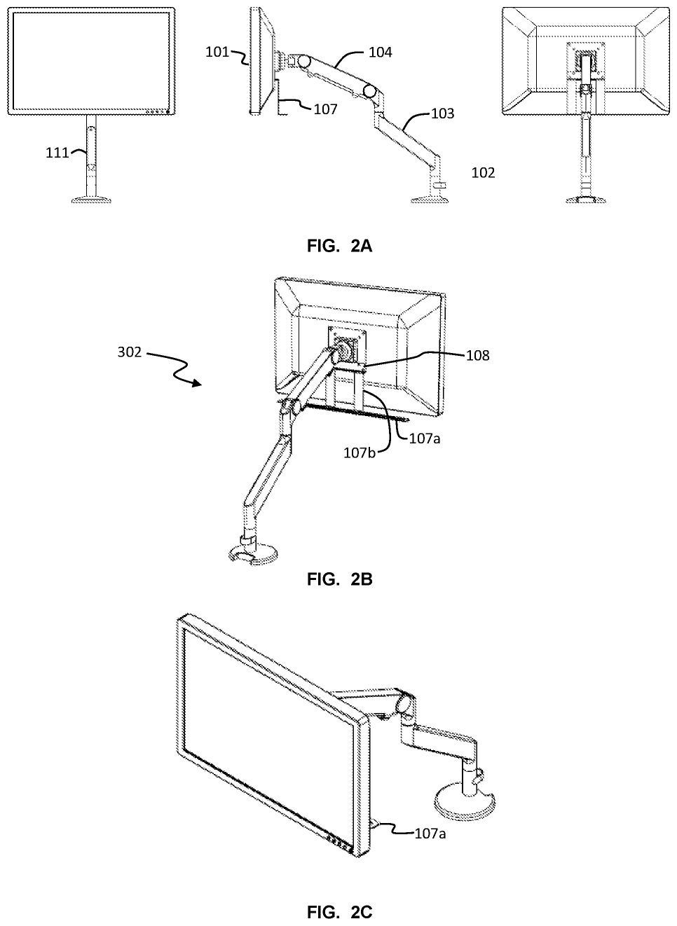

In some embodiments of the present invention, as seen in FIGS. 2A-C, a computer display accessory mount system 302 has a computer display 101 supported by a display support 111. The display support 111 may have a base 102, a lower arm 103, an upper arm 104, and be adapted to allow for movement of the display 101. The display may have a display mount interface 108 on its back side, which may be a standardized interface such as a VESA compliant interface. A lower horizontal mounting bar 107 is adapted to support accessories that may be used with the computer system. The lower mounting bar 107 has first and second coupling bars 107b which are adapted to utilize the display interface for mounting to the display 101, along with the display support 111. The mounting bar 107a is perpendicular to the coupling bars 107b, and may contain a slot 107c which may allow for the coupling or accessories at different stations along the mounting bar 107a. In some aspects, the mounting bar 107a is positioned just along the periphery of the display.

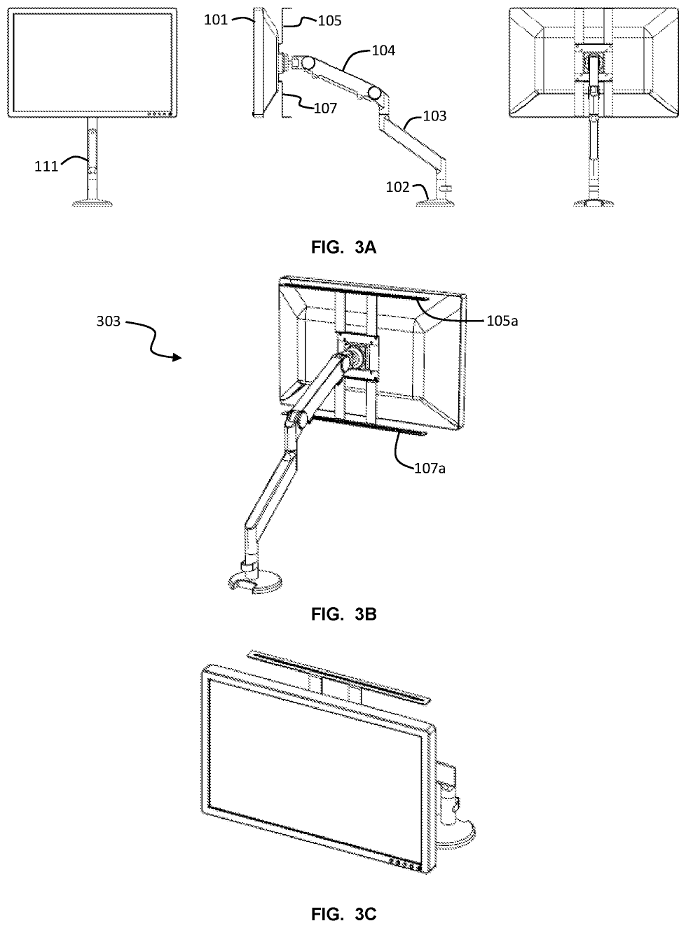

In some embodiments of the present invention, as seen in FIGS. 3A-C, a computer display accessory mount system 303 has a computer display 101 supported by a display support 111. . A lower horizontal mounting bar 107 is adapted to support accessories that may be used with the computer system. An upper horizontal mounting bar 105 is adapted to support accessories that may be used with the computer system.

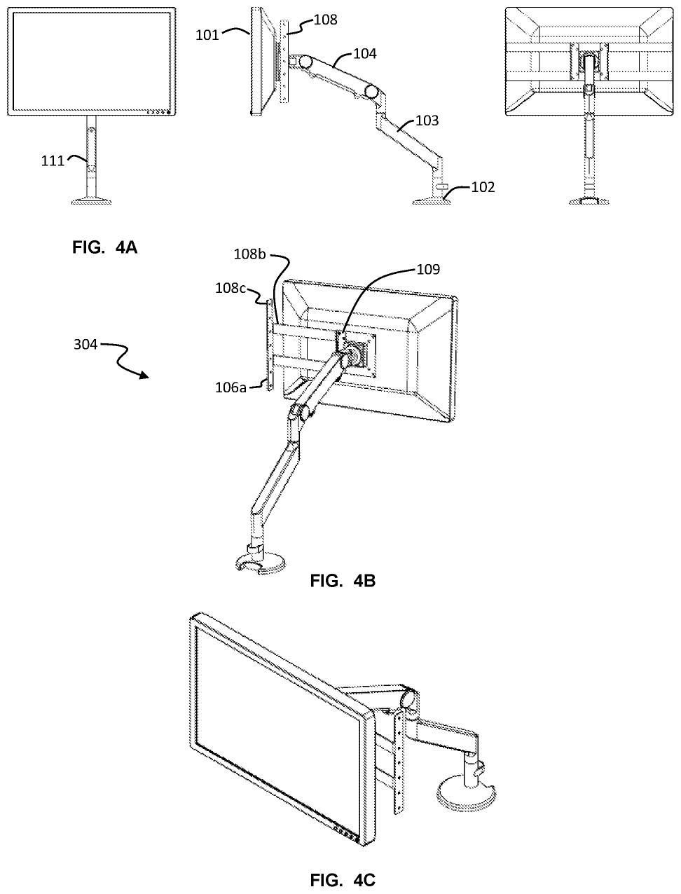

In some embodiments of the present invention, as seen in FIGS. 4A-C, a computer display accessory mount system 304 has a computer display 101 supported by a display support 111. The display support 111 may have a base 102, a lower arm 103, an upper arm 104, and be adapted to allow for movement of the display 101. The display may have a display mount interface 106 on its back side, which may be a standardized interface such as a VESA compliant interface. A right side mounting bar 108 is adapted to support accessories that may be used with the computer system. The right side vertical mounting bar 108 has first and second coupling bars 108b which are adapted to utilize the display interface for mounting to the display 101, along with the display support 111. The mounting bar 108a is perpendicular to the coupling bars 108b, and may contain a mounting holes 108c which may allow for the coupling or accessories at different stations along the mounting bar 108a. In some aspects, the mounting bar 108a is positioned just along the periphery of the display.

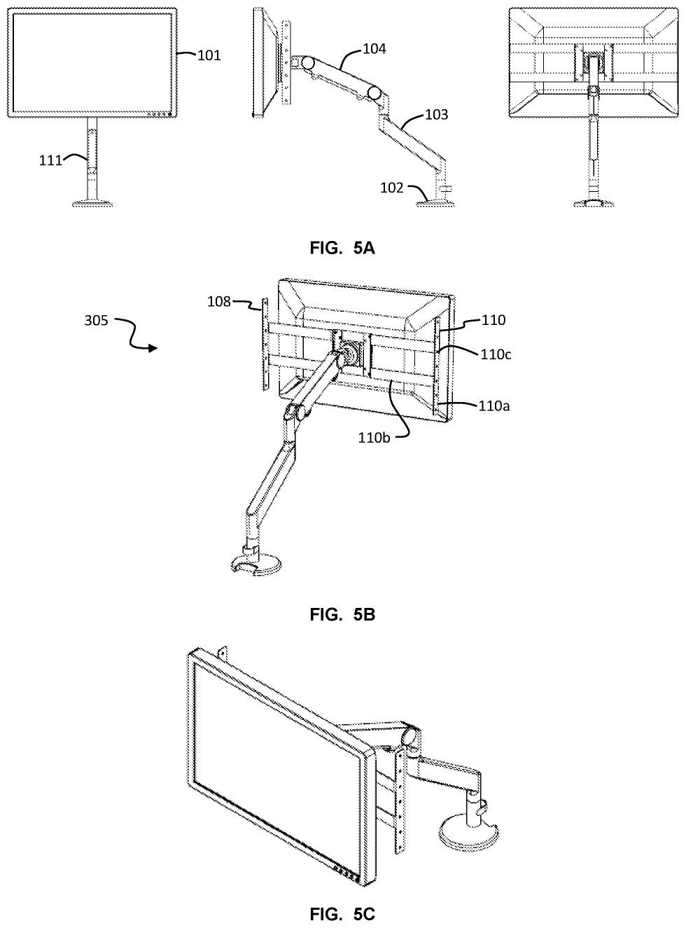

In some embodiments of the present invention, as seen in FIGS. 5A-C, a computer display accessory mount system 305 has a computer display 101 supported by a display support 111. A right side mounting bar 108 is adapted to support accessories that may be used with the computer system. A left side mounting bar 110 is adapted to support accessories that may be used with the computer system. The mounting bar 110a is perpendicular to the coupling bars 110b, and may contain a mounting holes 110c which may allow for the coupling or accessories at different stations along the mounting bar 110a.

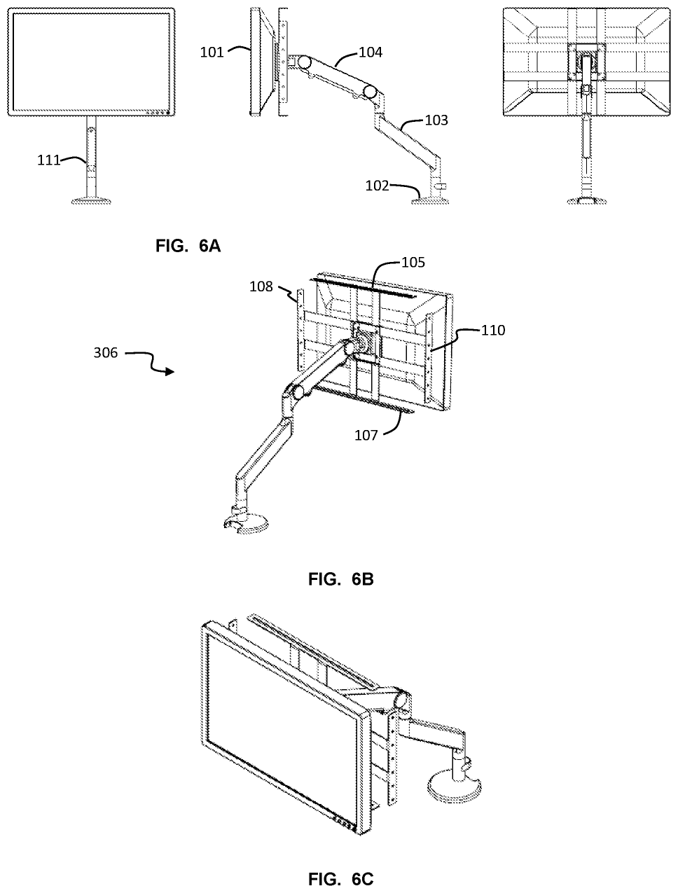

In some embodiments of the present invention, as seen in FIGS. 6A-C, a computer display accessory mount system 306 has a computer display 101 supported by a display support 111. A right side mounting bar 108 is adapted to support accessories that may be used with the computer system. A left side mounting bar 110 is adapted to support accessories that may be used with the computer system. A lower horizontal mounting bar 107 is adapted to support accessories that may be used with the computer system. An upper horizontal mounting bar 105 is adapted to support accessories that may be used with the computer system.

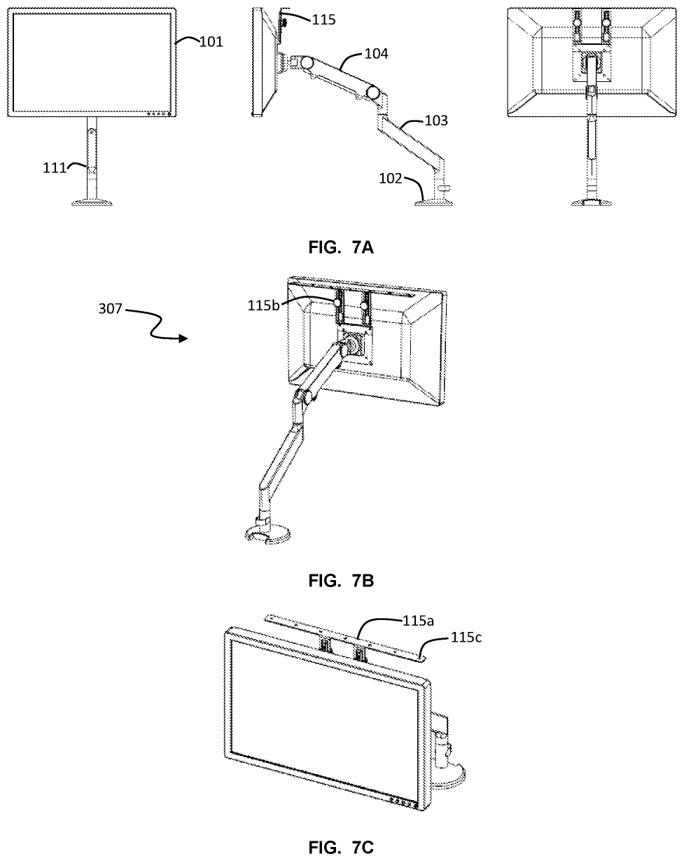

In some embodiments of the present invention, as seen in FIGS. 7A-C, a computer display accessory mount system 307 has a computer display 101 supported by a display support 111. The display support 111 may have a base 102, a lower arm 103, an upper arm 104, and be adapted to allow for movement of the display 101. The display may have a display mount interface 106 on its back side, which may be a standardized interface such as a VESA compliant interface. An adjustable upper horizontal mounting bar 115 is adapted to support accessories that may be used with the computer system. The upper horizontal mounting bar 115 has first and second coupling bars 115b which are adapted to utilize the display interface for mounting to the display 101, along with the display support 111. The coupling bars 115b are adjustable such that their length may be extended or retracted. The mounting bar 115a is perpendicular to the coupling bars 115b, and may contain a slot 115c which may allow for the coupling or accessories at different stations along the mounting bar 115a. In some aspects, the mounting bar 115a is positioned just along the periphery of the display.

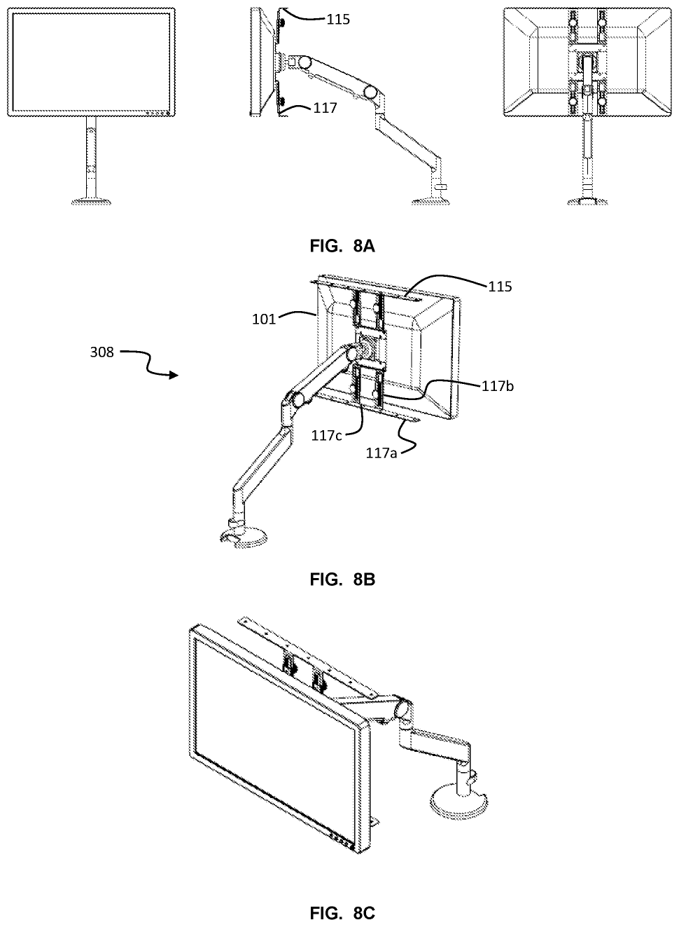

In some embodiments of the present invention, as seen in FIGS. 8A-C, a computer display accessory mount system 308 has a computer display 101 supported by a display support 111. The display support 111 may have a base 102, a lower arm 103, an upper arm 104, and be adapted to allow for movement of the display 101. The display may have a display mount interface 106 on its back side, which may be a standardized interface such as a VESA compliant interface. An adjustable upper horizontal mounting bar 115 is adapted to support accessories that may be used with the computer system. The upper horizontal mounting bar 115 has first and second coupling bars 115b which are adapted to utilize the display interface for mounting to the display 101, along with the display support 111. The coupling bars 115b are adjustable such that their length may be extended or retracted. The mounting bar 115a is perpendicular to the coupling bars 115b, and may contain a slot or mounting holes 115c which may allow for the coupling or accessories at different stations along the mounting bar 115a. In some aspects, the mounting bar 115a is positioned just along the periphery of the display. An adjustable lower horizontal mounting bar 117 is adapted to support accessories that may be used with the computer system. The lower horizontal mounting bar 117 has first and second coupling bars 117b which are adapted to utilize the display interface for mounting to the display 101, along with the display support 111. The coupling bars 117b are adjustable such that their length may be extended or retracted. The mounting bar 117a is perpendicular to the coupling bars 117b, and may contain a slot or mounting holes 117c which may allow for the coupling or accessories at different stations along the mounting bar 117a. In some aspects, the mounting bar 117a is positioned just along the periphery of the display.

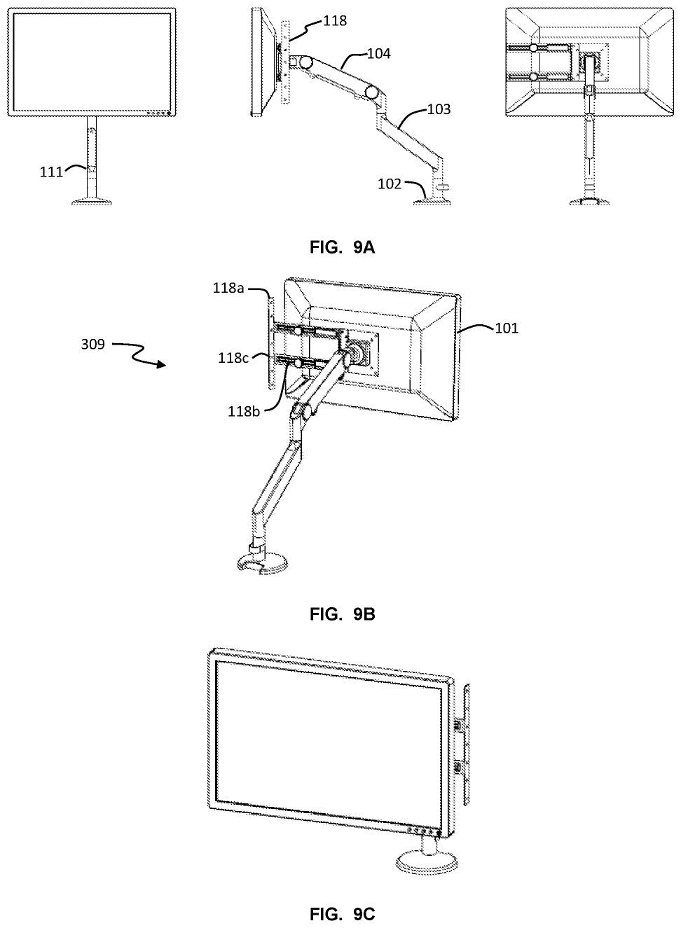

In some embodiments of the present invention, as seen in FIGS. 9A-C, a computer display accessory mount system 309 has a computer display 101 supported by a display support 111. The display support 111 may have a base 102, a lower arm 103, an upper arm 104, and be adapted to allow for movement of the display 101. The display may have a display mount interface 106 on its back side, which may be a standardized interface such as a VESA compliant interface. An adjustable right side mounting bar 118 is adapted to support accessories that may be used with the computer system. The right side vertical mounting bar 118 has first and second adjustable coupling bars 118b which are adapted to utilize the display interface for mounting to the display 101, along with the display support 111. The coupling bars 118b are adjustable such that their length may be extended or retracted. The mounting bar 118a is perpendicular to the coupling bars 118b, and may contain a slot or mounting holes 118c which may allow for the coupling or accessories at different stations along the mounting bar 118a. In some aspects, the mounting bar 118a is positioned just along the periphery of the display.

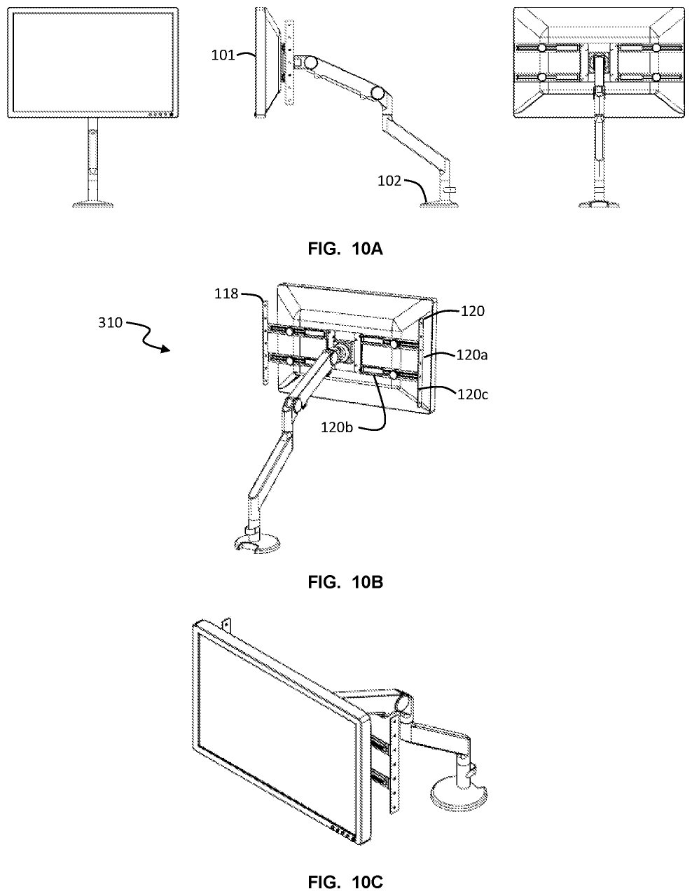

In some embodiments of the present invention, as seen in FIGS. 10A-C, a computer display accessory mount system 310 has a computer display 101 supported by a display support 111. The display support 111 may have a base 102, a lower arm 103, an upper arm 104, and be adapted to allow for movement of the display 101. The display may have a display mount interface 106 on its back side, which may be a standardized interface such as a VESA compliant interface. An adjustable right side mounting bar 118 is adapted to support accessories that may be used with the computer system. The right side vertical mounting bar 118 has first and second adjustable coupling bars 118b which are adapted to utilize the display interface for mounting to the display 101, along with the display support 111. An adjustable left side mounting bar 120 is adapted to support accessories that may be used with the computer system. The left side vertical mounting bar 120 has first and second coupling bars 120b which are adapted to utilize the display interface for mounting to the display 101, along with the display support 111. The coupling bars 120b are adjustable such that their length may be extended or retracted. The mounting bar 120a is perpendicular to the coupling bars 120b, and may contain a slot or mounting holes 120c which may allow for the coupling or accessories at different stations along the mounting bar 120a. In some aspects, the mounting bar 120a is positioned just along the periphery of the display.

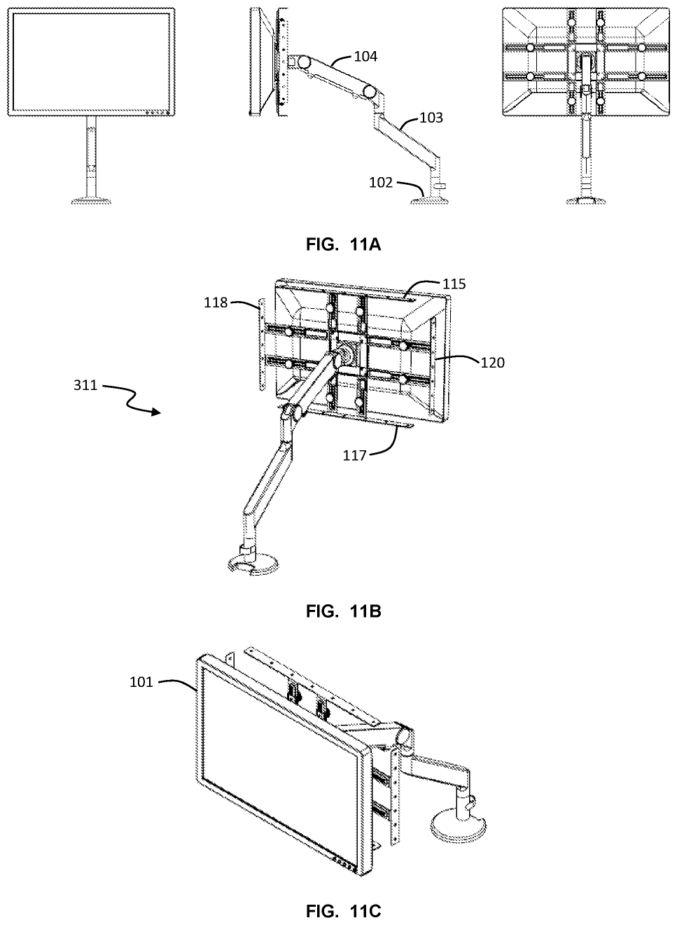

In some embodiments of the present invention, as seen in FIGS. 11A-C, a computer display accessory mount system 311 has a computer display 101 supported by a display support 111. The display support 111 may have a base 102, a lower arm 103, an upper arm 104, and be adapted to allow for movement of the display 101. An adjustable right side mounting bar 118 is adapted to support accessories that may be used with the computer system. An adjustable left side mounting bar 120 is adapted to support accessories that may be used with the computer system. An adjustable upper mounting bar 115 is adapted to support accessories that may be used with the computer system. An adjustable lower mounting bar 117 is adapted to support accessories that may be used with the computer system.

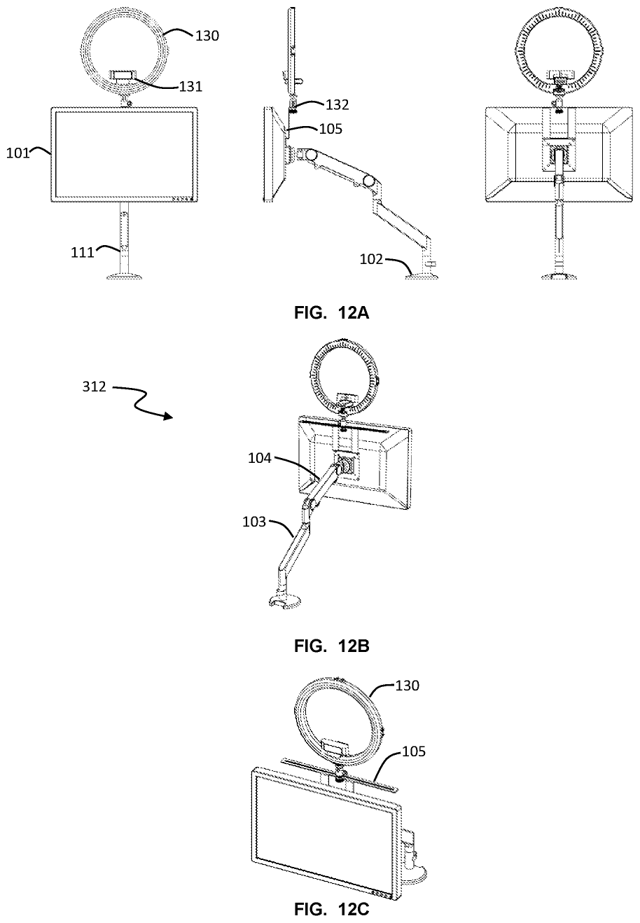

In some embodiments of the present invention, as seen in FIGS. 12A-C, a computer display accessory mount system 312 has a computer display 101 supported by a display support 111. The display support 111 may have a base 102, a lower arm 103, an upper arm 104, and be adapted to allow for movement of the display 101. The display may have a display mount interface 106 on its back side, which may be a standardized interface such as a VESA compliant interface. An upper horizontal mounting bar 105 is adapted to support accessories that may be used with the computer system. The upper horizontal mounting bar 105 has first and second coupling bars 105b which are adapted to utilize the display interface for mounting to the display 101, along with the display support 111. The mounting bar 105a is perpendicular to the coupling bars 105b, and may contain a slot 105c which may allow for the coupling or accessories at different stations along the mounting bar 105a. In some aspects, the mounting bar 105a is positioned just along the periphery of the display.

A circle light 130 is coupled to the upper horizontal mounting bar 105. The circle light may be coupled to the mounting bar with a positionally adjustable mount 132, which may be a ball head type device. The positionally adjustable mount 132 is adapted to route through the slot 105c, and may have a threaded fastener system which clamps the mount 132 to the mounting bar 105a. Also, a computer video camera and microphone combination 131 may be coupled to the mounting bar and may reside within the center area of the circle light 130.

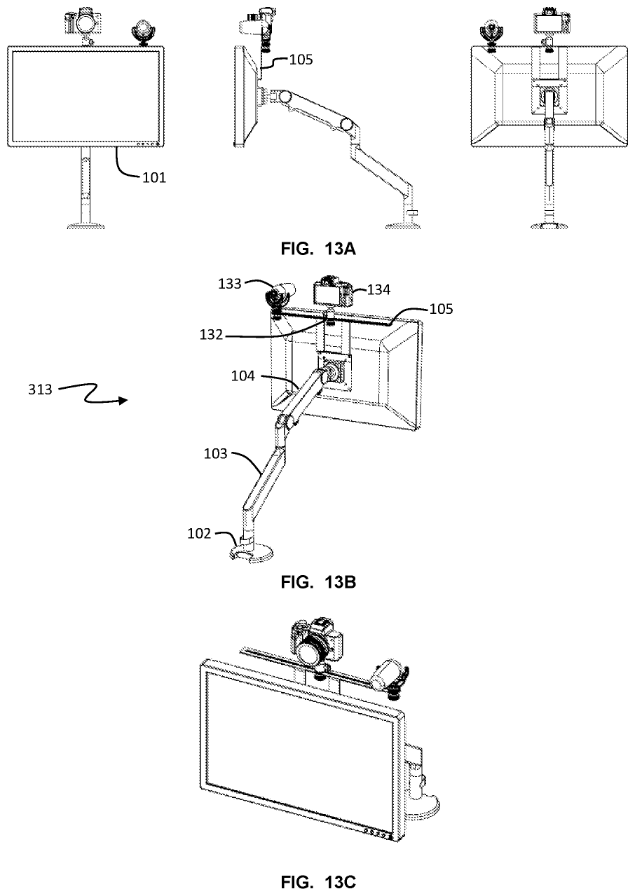

In some embodiments of the present invention, as seen in FIGS. 13A-C, a computer display accessory mount system 313 has a computer display 101 supported by a display support 111. The display support 111 may have a base 102, a lower arm 103, an upper arm 104, and be adapted to allow for movement of the display 101. The display may have a display mount interface 106 on its back side, which may be a standardized interface such as a VESA compliant interface. An upper horizontal mounting bar 105 is adapted to support accessories that may be used with the computer system. The upper horizontal mounting bar 105 has first and second coupling bars 105b which are adapted to utilize the display interface for mounting to the display 101, along with the display support 111. The mounting bar 105a is perpendicular to the coupling bars 105b, and may contain a slot 105c which may allow for the coupling or accessories at different stations along the mounting bar 105a. In some aspects, the mounting bar 105a is positioned just along the periphery of the display.

A camera 134 is coupled to the upper horizontal mounting bar 105. The camera may be coupled to the mounting bar with a positionally adjustable mount 132, which may be a ball head type device. The positionally adjustable mount 132 is adapted to route through the slot 105c, and may have a threaded fastener system which clamps the mount 132 to the mounting bar 105a. Also, a microphone 133 may be coupled to the mounting bar with a positionally adjustable mount 132.

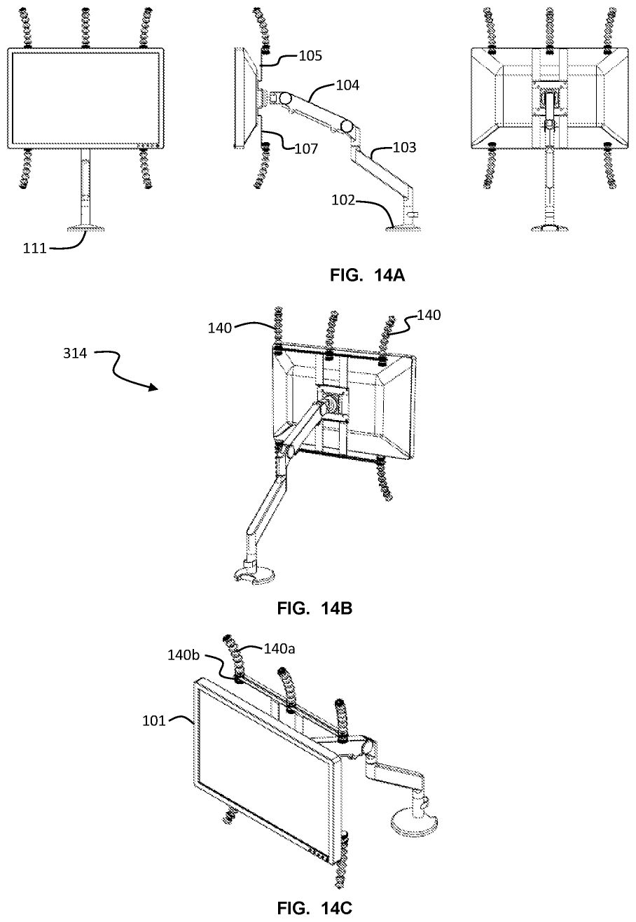

In some embodiments of the present invention, as seen in FIGS. 14A-C, a computer display accessory mount system 314 has a computer display 101 supported by a display support 111. A lower horizontal mounting bar 107 is adapted to support accessories that may be used with the computer system. An upper horizontal mounting bar 105 is adapted to support accessories that may be used with the computer system. Flexible support arms 140 are seen coupled to the upper and lower horizontal mounting bars 105, 107. The flexible support arms 140 may be of ball and socket connectors adapted to allow for the setting of different positions, and have enough frictional hold to support devices in a fixed position once set. The flexible support arms may have a threaded post at their outboard end adapted to couple to a threaded insert in a camera, a microphone, a light, or other device.

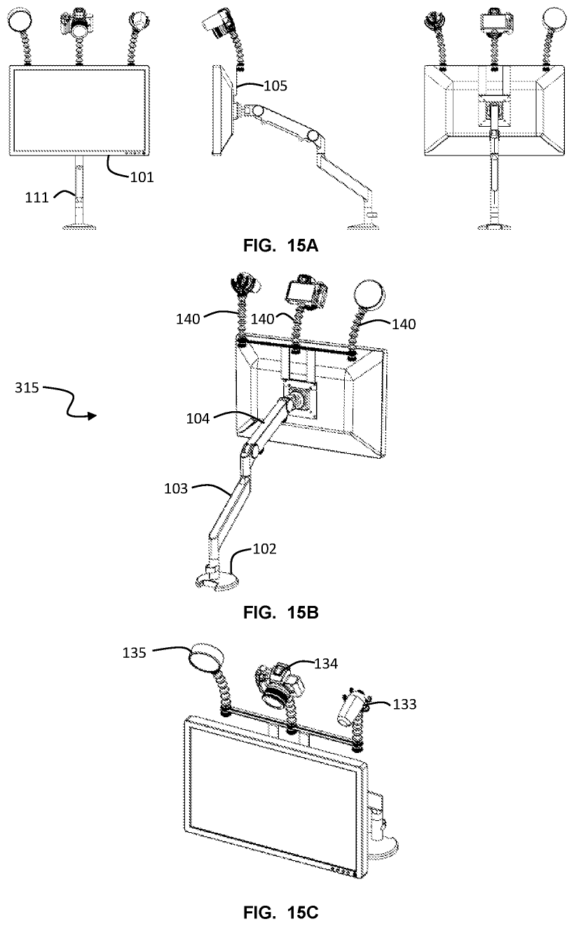

In some embodiments of the present invention, as seen in FIGS. 15A-C, a computer display accessory mount system 315 has a computer display 101 supported by a display support 111. An upper horizontal mounting bar 105 is adapted to support accessories that may be used with the computer system. Flexible support arms 140 are seen coupled to the upper horizontal mounting bar 105. The flexible support arms 140 may be of ball and socket connectors adapted to allow for the setting of different positions, and have enough frictional hold to support devices in a fixed position once set. The flexible support arms may have a threaded post at their outboard end adapted to couple to a threaded insert in a camera, a microphone, a light, or other device. In this illustrative embodiment, a microphone 133, a camera 134, and a light 140 are supported and positioned for use as accessories by the user.

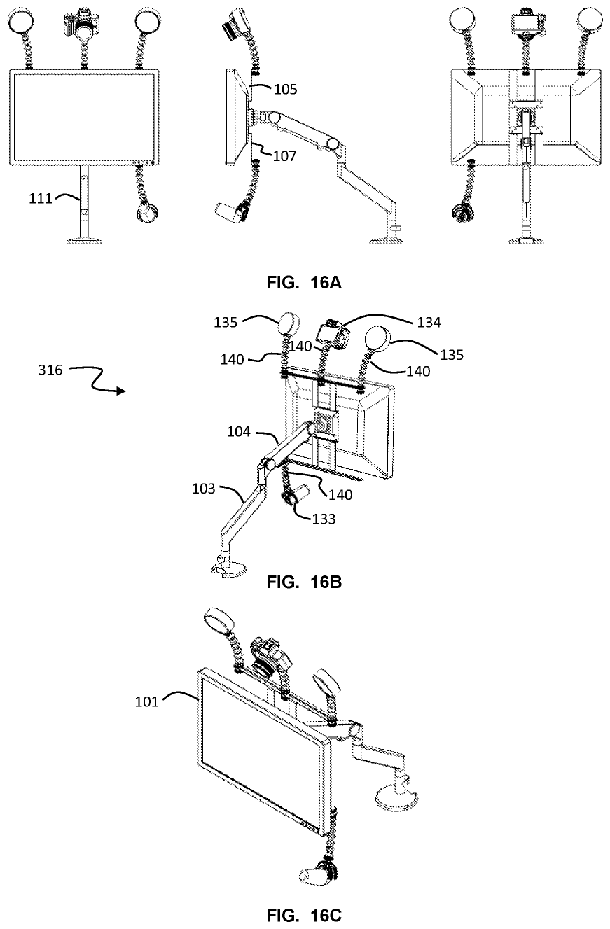

In some embodiments of the present invention, as seen in FIGS. 16A-C, a computer display accessory mount system 316 has a computer display 101 supported by a display support 111. An upper horizontal mounting bar 105 is adapted to support accessories that may be used with the computer system. A lower horizontal mounting bar 107 is adapted to support accessories that may be used with the computer system. Flexible support arms 140 are seen coupled to the upper horizontal mounting bar 105 and the lower horizontal mounting bar 107. The flexible support arms 140 may be of ball and socket connectors adapted to allow for the setting of different positions, and have enough frictional hold to support devices in a fixed position once set. The flexible support arms may have a threaded post at their outboard end adapted to couple to a threaded insert in a camera, a microphone, a light, or other device. In this illustrative embodiment, a microphone 133, a camera 134, and two lights 140 are supported and positioned for use as accessories by the user.

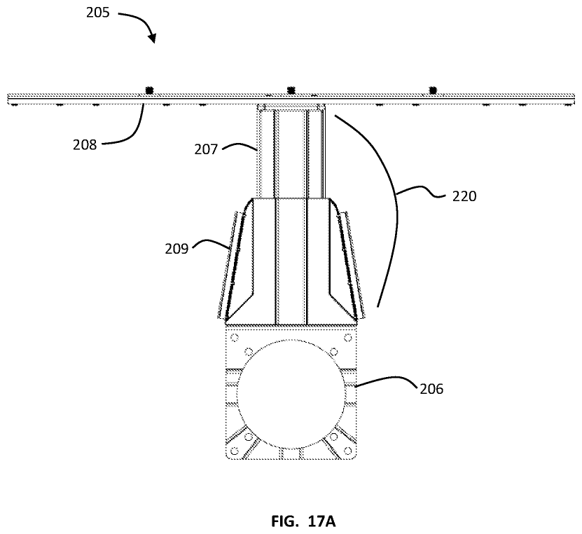

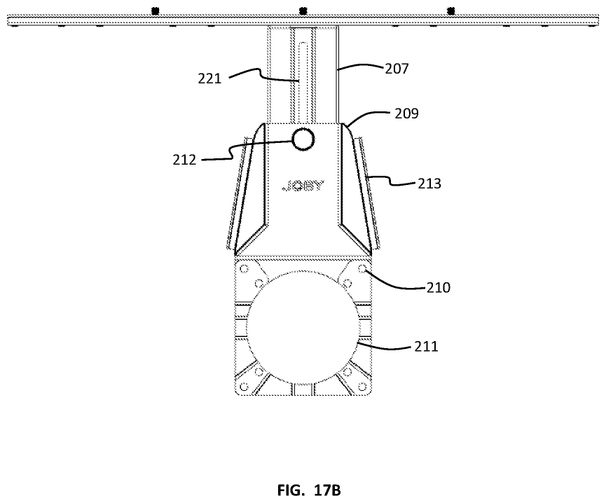

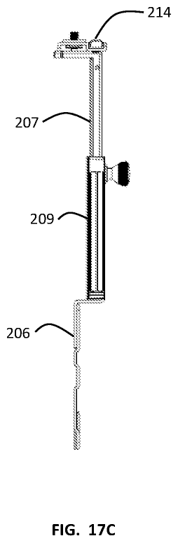

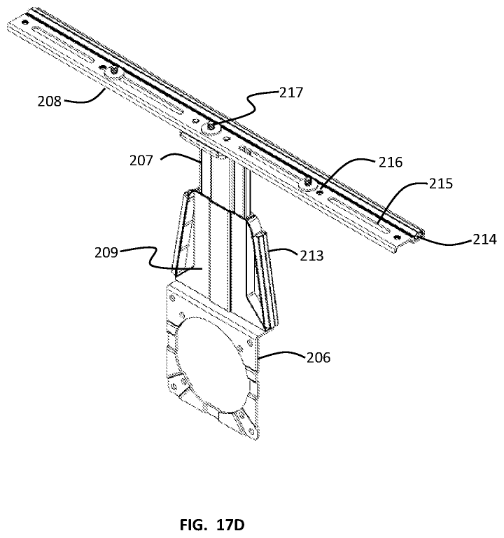

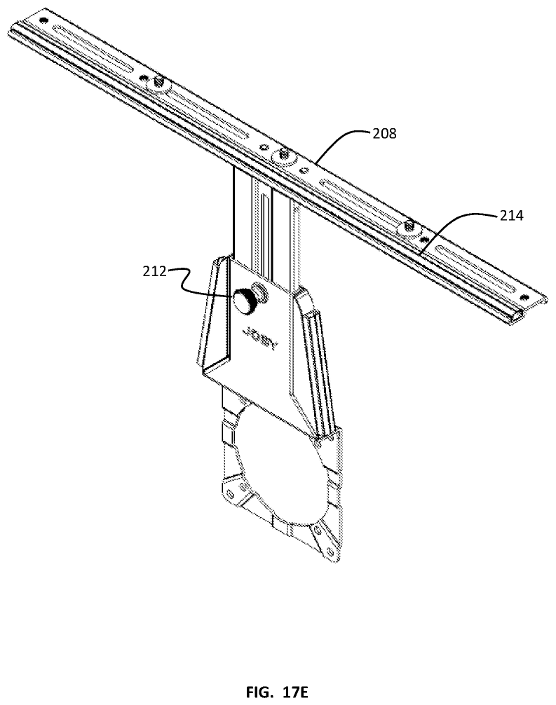

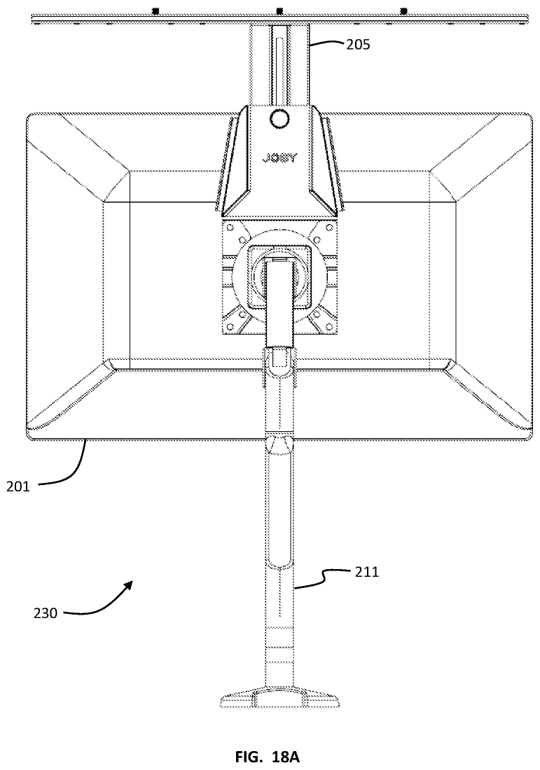

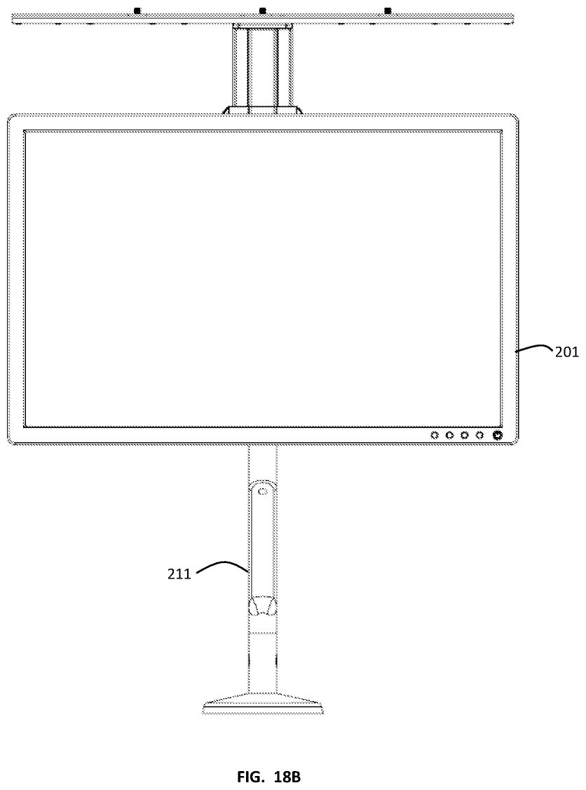

In some embodiments of the present invention, as seen in FIGS. 17A-E, a computer display accessory mount 205 may have a display accessory mount interface plate 206 on a bottom end, which may be configured to mount to a standardized interface such as a VESA compliant interface. A mounting bar 208 is adapted to support accessories that may be used with the accessory mount. The horizontal mounting bar 208 is coupled to an extension unit 220, which may have an upper portion 207 and a lower portion 209. The lower portion 209 of the extension unit 220 is coupled to the accessory mount interface plate 206. The extension unit is configured to allow for extension of the upper portion 207 and the mounting bar 205 relative to the lower portion 207 and the accessory mount interface plate 206. In some aspects, the upper portion and lower portion have guiding features to allow for a sliding extension in the extension axis. A tightening knob 212 allows for tightening of the upper portion and lower portion together to prevent further motion once the user has set the upper portion at the desired extension position. A slot 221 in the upper portion 207 allows for the linear motion of the upper portion, while the tightening feature, such as a bolt or post, remains in a fixed position through the lower portion 209. The upper portion may be moved to the desired position and then the knob may be tightened, setting the position. A side cable run 213 may be mounted on one or both sides of the lower portion 209 and is adapted to capture cables that may be running up to accessories mounted onto the horizontal mounting bar. The cable runs may be of a resilient material such as TPE, and may be shaped in cross-section as U-shaped or C-shaped in a fashion that allows for a cable to be pushed down into the annulus portion of the channel and then be retained by the resilient capture of the cable by the cable run.

The accessory mount interface plate is adapted to be mounted to the back of a display screen, and may be mounted captured between the display screen and a display support, as discussed further below. Thus, the tightening knob 212 may face rearward from the display screen, while the horizontal bar 208 may be positioned near or above the top of the display screen such that the front of the horizontal bar faces a direction opposite of that of the tightening knob. The horizontal bar 208 may include one or more slots 215, one or more holes 216, and may also include one or more threaded posts 217. In some aspects, the threaded posts 217 may be held in place with resilient collars, made of a material such as TPE. Rearward of the slots, holes, and posts there may be an upper cable run 214 adapted to capture cables from accessories that may be mounted on the horizontal bar 208. In some aspects, the horizontal bar 208 may have a recess within which the upper cable run 214 resides. The upper cable run and the recess within the bar may have through holes which allow for routing of the cables not only along the cable run but also through the cable run, and into a position which may be behind the display. In some aspects, the mounting portion of the mounting bar may be recessed from underneath, while the cable run portion of the mounting bar may be recessed from above.

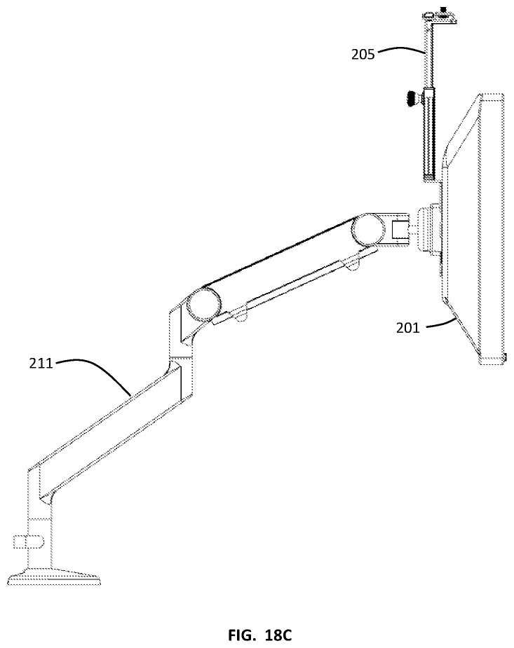

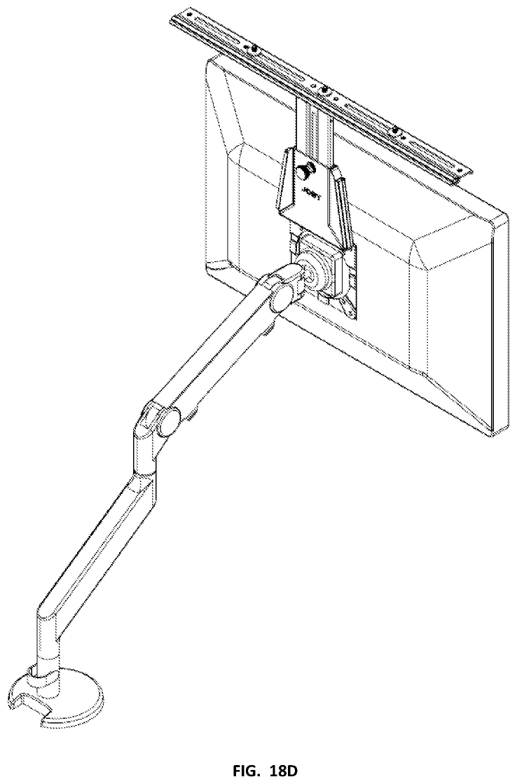

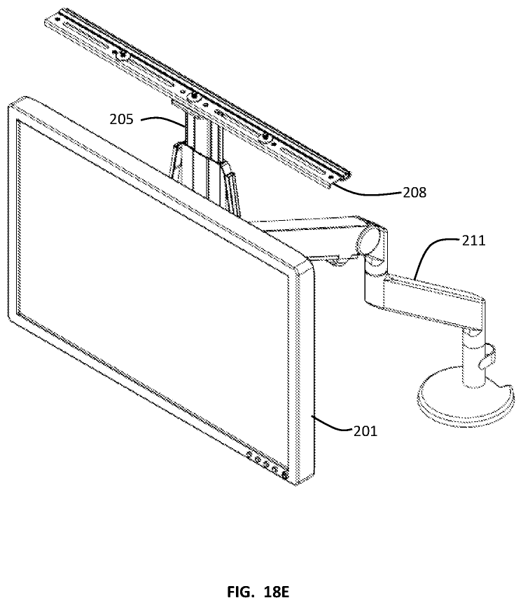

In some embodiments of the present invention, as seen in FIGS. 18A-E, a computer display accessory mount system 230 has a computer display 201 supported by a display support 211. The display support 211 may have a base, a lower arm, an upper arm, and be adapted to allow for movement of the display 201. The display may have a display mount interface on its back side, which may be a standardized interface such as a VESA compliant interface. The accessory mount interface plate 206 is configured to have its through holes align with the mounting holes in the display 201 and the display support 211, such that the accessory mount interface plate 206 is captured between the display support and the display, with the same mounting hardware as used to affix the display to the display support. Typically, the display 211 will have threaded holes adapted to receive threaded fasteners. A computer display accessory mount 205 is adapted to support accessories that may be used with the computer system. The upper mounting bar 208 has an extension unit 220 which is adapted to utilize the display interface for mounting to the display 101, along with the display support 111, as discussed above. The mounting bar 208 of the computer display accessory mount may contain slots, posts, holes, and cable runs as discussed above. In some aspects, the mounting bar 108 is positioned just along the upper periphery of the display.

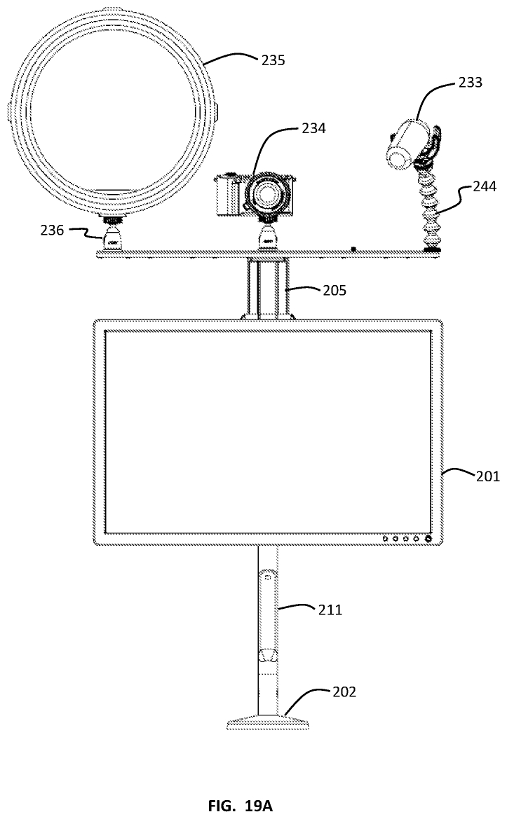

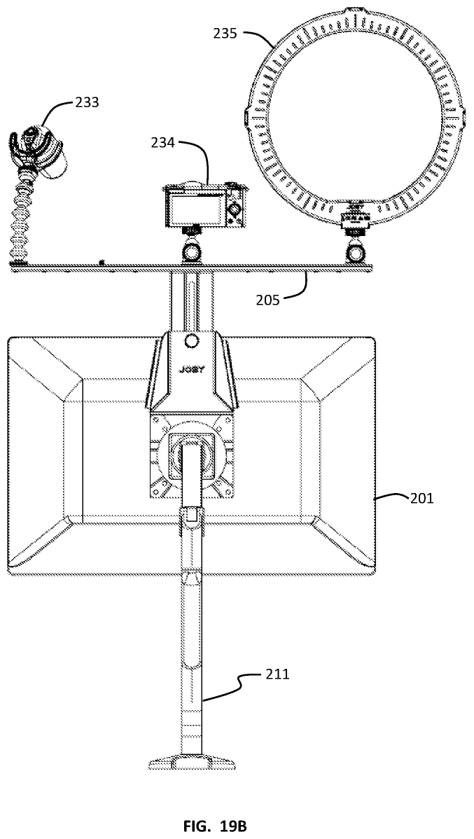

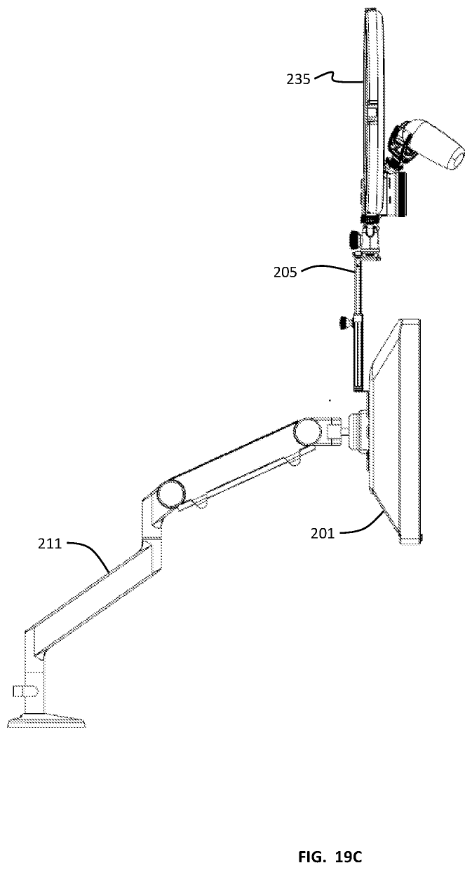

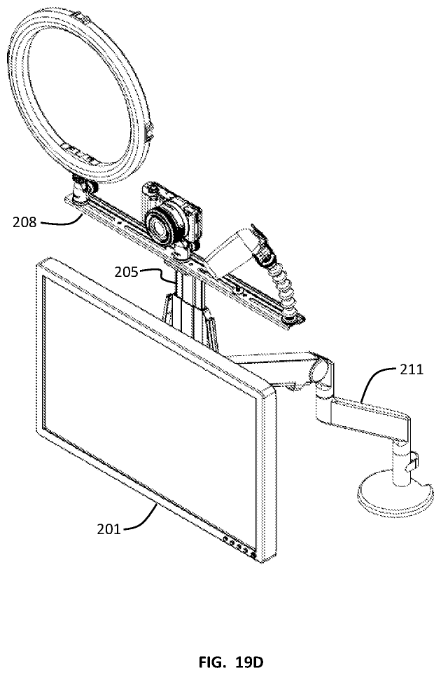

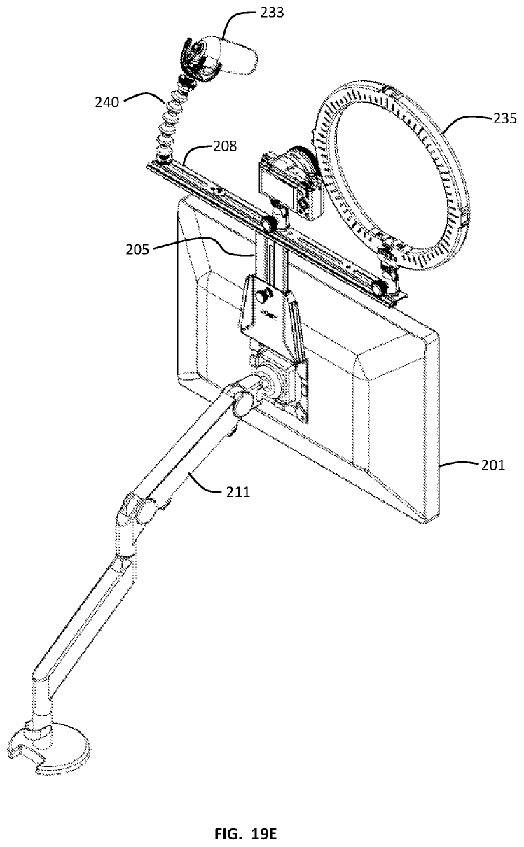

In some embodiments of the present invention, as seen in FIGS. 19A-E, a computer display accessory mount system has a computer display 201 supported by a display support 211. The display support 211 may have a base, a lower arm, an upper arm, and be adapted to allow for movement of the display 201. The display may have a display mount interface on its back side, which may be a standardized interface such as a VESA compliant interface. A computer display accessory mount 205 is adapted to support accessories that may be used with the computer system. A horizontal mounting bar 208 is adapted to support mounting of accessories that may be used with the computer system. The upper mounting bar 208 has an extension unit 220 which is adapted to utilize the display interface for mounting to the display 201, along with the display support 211. The mounting bar 208 may contain slots, posts, holes, and cable runs as discussed above. In some aspects, the mounting bar 208 is positioned just along the upper periphery of the display.

A camera 234 may be coupled to the horizontal mounting bar 208. The camera may be coupled to the mounting bar with a positionally adjustable mount 236, which may be a ball head type device. The positionally adjustable mount 236 is adapted to route through a slot in the horizontal, and may have a threaded fastener system which clamps the mount to the mounting bar. In some aspects, the positionally adjustable mount 236 fastens to a threaded post on the horizontal bar. A microphone 233 may be coupled to the mounting bar on a flexible arm 240. A ring light 235 may be coupled to the horizontal bar with a positionally adjustable mount 236. In some aspects, the different mounted accessories may be mounted directly to the mounting bar 208, or may be mounted using any of the intermediate mounts.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A system for the support of computer accessories, said system comprising:
a computer display stand, said computer display stand comprising a stand display interface;
a computer display, wherein said computer display is configured to align with said stand display interface at a plurality of display interface points on a back surface of said computer display; and
a computer display accessory mount, wherein said computer display accessory mount is captured between said stand display interface of said computer display stand and a back surface of said computer display.

2. The system of claim 1 wherein said computer display accessory mount comprises:
a display mount interface plate; and
a mounting bar.

3. The system of claim 2 wherein said computer display accessory mount further comprises an extension unit coupled to said display mount interface plate on a first end, and coupled to said mounting bar on a second end.

4. The system of claim 3 wherein said computer display accessory mount further comprises one or more cable run channels along a side of said computer display accessory mount.

4. The system of claim 4 further comprising one or more flexible mounting extensions coupled to said mounting bar.

5. The system of claim 4 further comprising a light coupled to said mounting bar.

6. The system of claim 4 further comprising a light coupled to one of said flexible mounting extensions.

7. The system of claim 2 further comprising a light coupled to said mounting bar.

8. The system of claim 4 further comprising a camera coupled to said mounting bar.

9. The system of claim 2 further comprising a camera coupled to said mounting bar.

10. The system of claim 4 further comprising a microphone coupled to said mounting bar.

11. The system of claim 2 further comprising a microphone coupled to said mounting bar.

12. A computer display accessory mount, said mount comprising:
a display mount interface plate; and
a mounting bar.

13. The computer display accessory mount of claim 12 further comprising an extension unit coupled to said display mount interface plate on a first end, and coupled to said mounting bar on a second end.

14. The computer display accessory mount of claim 13 further comprising one or more cable run channels along a side of said computer display accessory mount.

15. The computer display accessory mount of claim 13 wherein said mounting bar comprises one or more slots.

16. The computer display accessory mount of claim 13 wherein said mounting bar comprises one or more holes.

17. The computer display accessory mount of claim 13 wherein said mounting bar comprises one or more threaded mounting studs.

18. The computer display accessory mount of claim 13 further comprising a tightening knob configured to fasten said extension unit at a desired location.
